(19) United States
(12) Patent Application Publication
(10) Pub. No.: US 2022/0307753 A1
(43) Pub. Date: Sep. 29, 2022

(54) MULTIFUNCTIONAL VEHICLE-MOUNTED REFRIGERATOR WITH PLUG-IN BATTERY

(71) Applicant: Foshan Alpicool Electric Appliance Co., LTD, Foshan (CN)

(72) Inventors: Shengming He, Nanxiong (CN); Jianglong Shi, Baoji (CN); Dongmei Zeng, Wuzhou (CN)

(21) Appl. No.: 17/230,981

(22) Filed: Apr. 14, 2021

(30) Foreign Application Priority Data
Mar. 24, 2021 (CN) 202120599452.1

(51) Int. Cl. F25D 11/02; B62B 1/12; B62B 5/00; F25B 13/00

(52) U.S. Cl. CPC F25D 11/02; B62B 1/12; B62B 5/00; F25B 13/00

(57) ABSTRACT

Provided is a multifunctional vehicle-mounted refrigerator with a plug-in battery, which includes a refrigerator box, an openable cover, a refrigerating chamber and a freezing chamber arranged side by side in the refrigerator box, a compressor installed at the bottom of one side of the refrigerator, a roller arranged at one end of the bottom of the refrigerator box, and a telescopic pull rod arranged at the other end. A battery chamber is defined in one side wall of the refrigerator box, and a battery can be inserted into the battery chamber. The battery includes a battery box and a battery cover. Laterally movable buckle plates are symmetrically arranged between two ends of the battery cover. Two ends of the buckle plates extend from the respective ends of the battery cover, the central portion of the buckle plates is disposed outside the battery cover, and the buckle plates at both ends are connected together by an elastic piece, which is disposed in a limiting groove defined in the inner side of the battery cover.

### CROSS-REFERENCE TO RELATED APPLICATIONS

This is a U.S. patent application which claims the priority and benefit of Chinese Patent Application Number 202120599452.1, filed on Mar. 24, 2021, the disclosure of which is incorporated herein by reference in its entirety.

### TECHNICAL FIELD

This disclosure relates to the field of vehicle-mounted refrigerators, and more particularly relates to a multifunctional vehicle-mounted refrigerator with a plug-in battery.

### BACKGROUND

With the improvement of people's living standards, more and more people will put a car refrigerator in their cars when they drive out to play. In order to make the car refrigerator keep working, the car refrigerator generally comes with its own power supply, but most of the current car refrigerator power supplies cannot be removed, and can only be charged onsite, which is inconvenient to use.

There are also removable car refrigerator batteries on the market, but they have a complicated structure. In particular, they use many springs that are prone to jams, and the cost is relatively high.

Furthermore, many car refrigerators are now equipped with pull rods to facilitate the movement of the car refrigerators. These pull rods generally adopt the structure of inner and outer tubes. However, they are not provided with a locking and unlocking mechanism, so that the pull rod is likely to extend outside per se during use, and the extended pull rod is likely to be damaged by collision. Additionally, current car refrigerators have just a single function and are not able to meet the current needs of customers.

### SUMMARY

This disclosure provides a multifunctional vehicle-mounted refrigerator with a plug-in battery, which has a reasonable structure and diverse functions, can realize the disassembly and assembly of the battery, and the adjustment of the pull rod is convenient and reasonable.

In order to achieve the above object, the present disclosure provides the following technical solutions. There is provided a vehicle-mounted refrigerator that includes a refrigerator box, an openable cover arranged on the top of the refrigerator box, a refrigerating compartment and a freezing compartment that are arranged side by side in the refrigerator box, and a compressor that installed at the bottom of one side of the refrigerator box.

The vehicle-mounted refrigerator further includes a roller arranged at one end of the bottom of the refrigerator box and a telescopic pull rod arranged at the other end of the refrigerator box.

A battery chamber is provided in one side wall of the refrigerator box, and a battery is operative to be inserted into the battery chamber. The battery includes a battery box and a battery cover arranged at the upper end of the battery box. Laterally movable buckle plates are symmetrically arranged at both ends of the battery cover. The two ends of the buckle plates protrude from the respective ends of the battery cover. The central portion of the buckle plates is disposed outside the battery cover. The buckle plates at both ends are connected together by an elastic piece. The elastic piece is disposed in a limit groove defined in an inner side of the battery cover. A conductive socket is arranged in the battery chamber, and a conductive plug disposed on one side of the battery box is operative to be plugged into the conductive socket.

In one embodiment, a connecting groove is defined in an inner side of the buckle plates at a position corresponding to the elastic piece, and an elastic piece connecting portion is arranged at an end of the connecting groove.

In one embodiment, a switch button is installed on the battery cover, and a power indicator and a status indicator are arranged on one side of the switch button. The switch button, the power indicator and the status indicator are all coupled to a control circuit board arranged on an inner side of the battery cover.

In one embodiment, both sides of the refrigerator box are each installed with a pair of pull rod mounts, and a pull rod fixing tube is connected between the pull rod mounts on disposed on each side. An axially movable pull rod inner tube is installed inside the pull rod fixing tube. One end of the two pull rod inner tubes is connected by a pull rod. A movable shaft plug is axially inserted into and arranged at one end of each of the pull rod inner tubes connected with the pull rod. The outer end of the movable shaft plug is provided with an unlocking knob that is installed on a side wall of the pull rod. When the unlocking knob is rotated, the movable shaft plug is pushed to move axially. A fixing shaft plug is installed at the other end of the pull rod inner tube. A lock tongue is radially movably arranged inside the fixing shaft plug. One end of the lock tongue is equipped with a spring, and the other end is inserted into a lock hole defined in the side wall of the pull rod fixing tube. An unlocking push rod is arranged axially movable in the fixing shaft plug. One end of the unlocking push rod is provided with a slope and inserted into the middle of the lock tongue to push the lock tongue to move radially, and the other end of the unlocking push rod is connected with the movable shaft plug through a connecting shaft.

In one embodiment, the unlocking push rod is provided with an elongated limiting hole, and a protrusion inside the fixing shaft plug is embedded in the elongated limiting hole.

In one embodiment, the inner side wall of the cover is provided with at least one groove. A detachable fruit cutting board is embedded in the groove. One end of the groove is equipped with a rotating blocking plate, and the other end is provided with a convex plate on the side wall, and both ends of the fruit cutting board are restricted in the groove by the rotating blocking plate and the convex plate. The inner bottom surface of the groove is evenly distributed with raised blocks.

In one embodiment, a corner protection board is installed at the bottom of one end of the refrigerator box that is not equipped with rollers, and a corner protection boss is arranged transversely on the inner side of the corner protection board, and slopes are arranged on both sides of the corner protection boss.

In one embodiment, a rotating shaft is symmetrically arranged between the two ends at one side of the cover. In the center of the side of the cover facing away from the rotating shaft is installed a flip buckle cover, which is operative to be interlocked with the upper edge of the refrigerator box. The two ends of an inner side wall at the top of the refrigerator box are provided with vertical slots, and the bottom of each of the vertical slots is provided with a circular slot, and the rotating shaft is inserted and embedded into the circular slot along the vertical slot at either end.

In one embodiment, at least two types of power sockets are installed on one side of the refrigerator box below the battery chamber.

In one embodiment, a storage basket is installed inside the refrigerating chamber and/or freezing chamber.

Compared with the related art, the present disclosure provides the following benefits.

Reasonable structure, diverse functions, and each of operation. It can realize the installation and removal of the battery. The battery adopts the structure of an elastic piece which is limited in position, so that when the buckle plate moves and the elastic part is squeezed they will not run astray, thus preventing jamming. The vehicle-mounted refrigerator is provided with an unlocking structure, whereby the pull rod can be kept in a retracted state to prevent it from extending by itself thereby protecting the pull rod. The vehicle-mounted refrigerator is further equipped with a fruit cutting board, making it convenient to cut fruits or other food outdoors or in the car, eliminating the need to bring an additional fruit cutting board, which may otherwise affect the normal use of the car refrigerator, thereby providing convenience of use.

### BRIEF DESCRIPTION OF DRAWINGS

FIG. 1 is a perspective view of the structure of the present disclosure.

FIG. 2 is a perspective view of a partial structure of the present disclosure.

FIG. 3 is a front view of the structure of the present disclosure.

FIG. 4 is a front view of a half-sectional structure of the present disclosure.

FIG. 5 is a partial enlarged view of the structure at A shown in FIG. 2.

FIG. 6 is a partial enlarged view of the structure at C shown in FIG. 4.

FIG. 7 is a three-dimensional schematic diagram of a battery according to the present disclosure.

FIG. 8 is a schematic diagram illustrating a local part of the battery according to the present disclosure.

FIG. 9 is a half-sectional structural diagram of the pull rod according to the present disclosure.

FIG. 10 is a partial enlarged view of the structure at B shown in FIG. 9.

FIG. 11 is a perspective view of the structure of the cover according to the present disclosure.

FIG. 12 is a side sectional view of the cover according to the present disclosure.

FIG. 13 is a circuit diagram of the display panel of according to the present disclosure.

FIG. 14 is a schematic diagram of the solar management part of the charging management board according to the present disclosure.

FIG. 15 is a schematic diagram of the lithium battery management part of the charge management board according to the present disclosure.

FIG. 16 is a circuit diagram of the control board according to the present disclosure.

### DETAILED DESCRIPTION

Hereinafter, technical solutions in the embodiments according to the present disclosure will be described in a definite and comprehensive manner in connection with the accompanying drawings in the embodiments according to the present disclosure. Apparently, the embodiments described herein are only a part, rather than all of the embodiments in accordance with the present disclosure. Based on the embodiments of the present disclosure, all other embodiments obtained by those having ordinary skill in the art without investing creative efforts shall all fall in the scope of protection of the present disclosure.

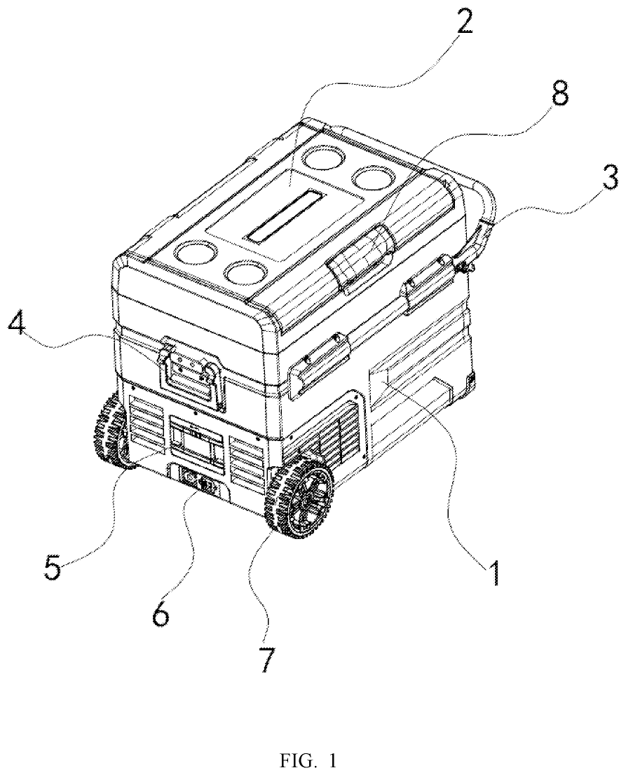

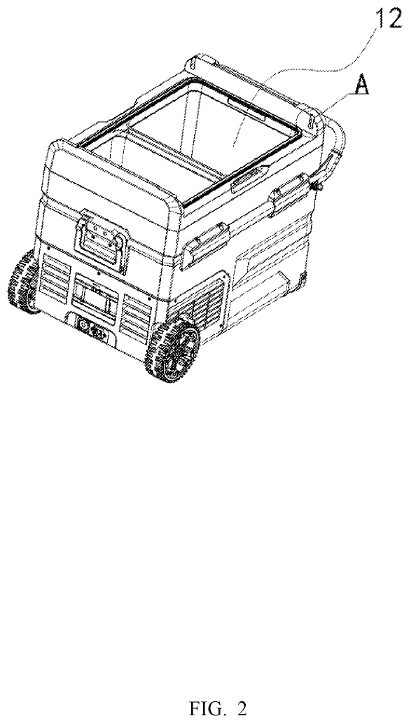

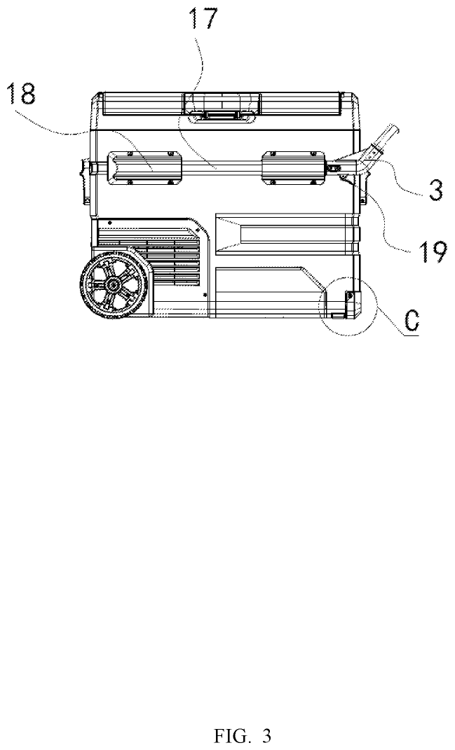

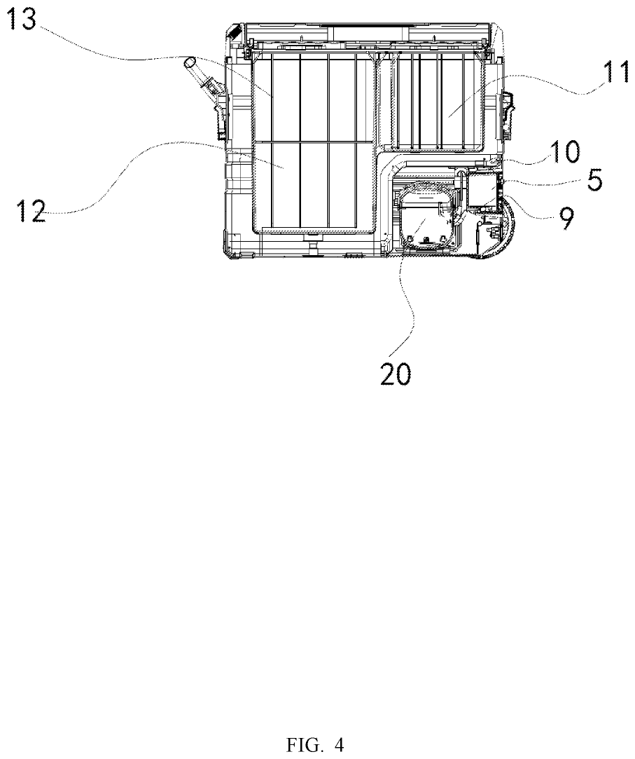

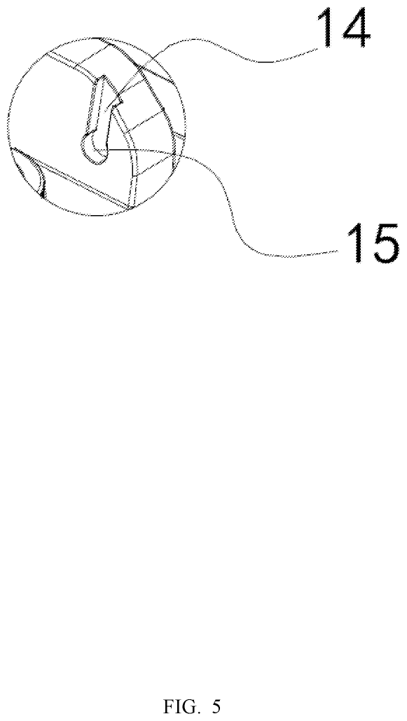

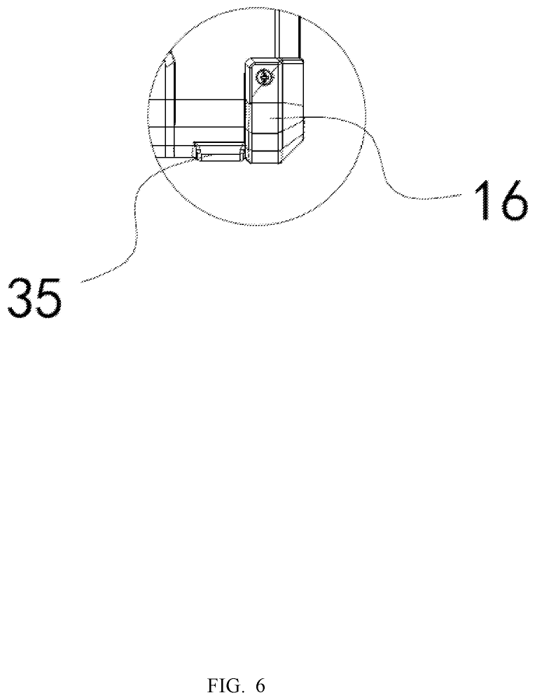

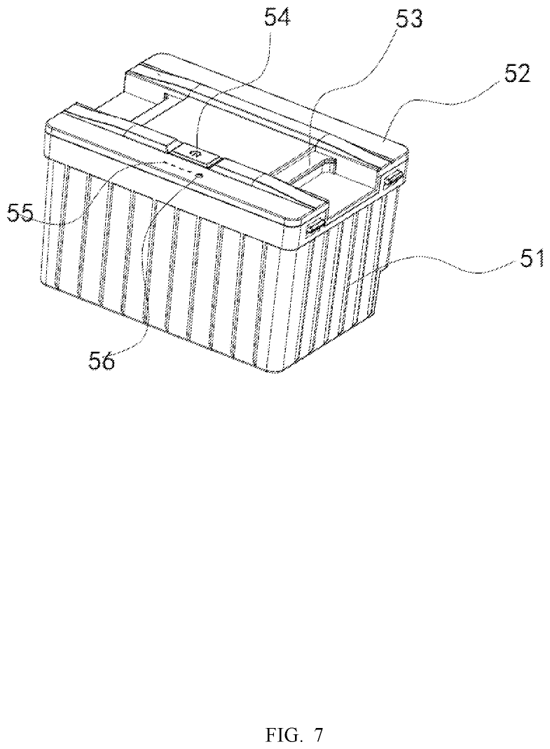

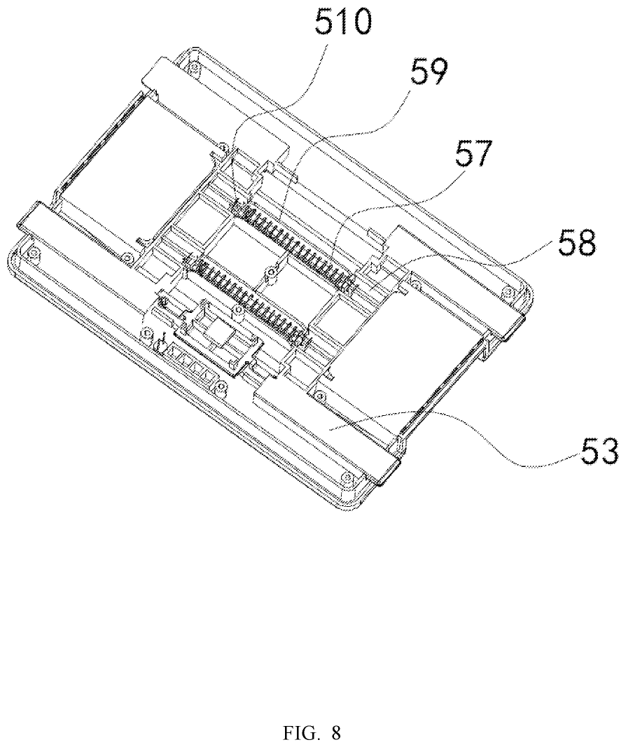

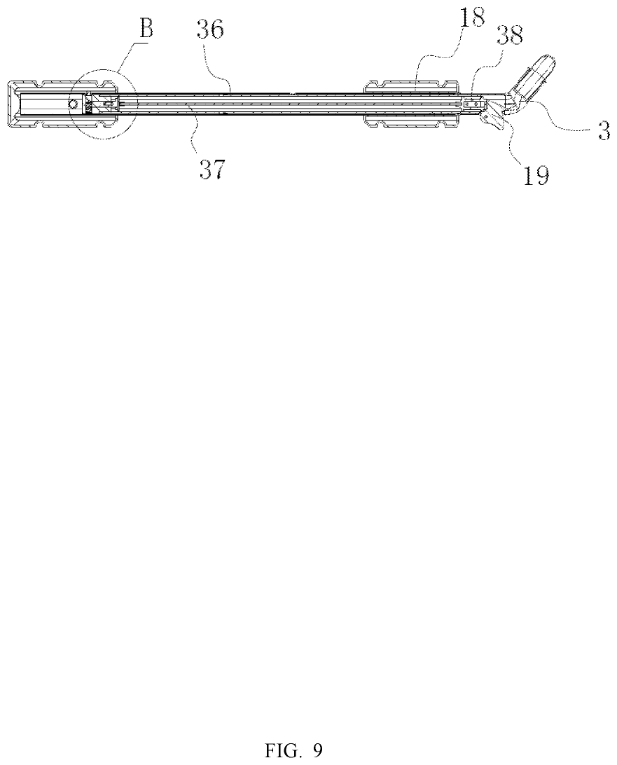

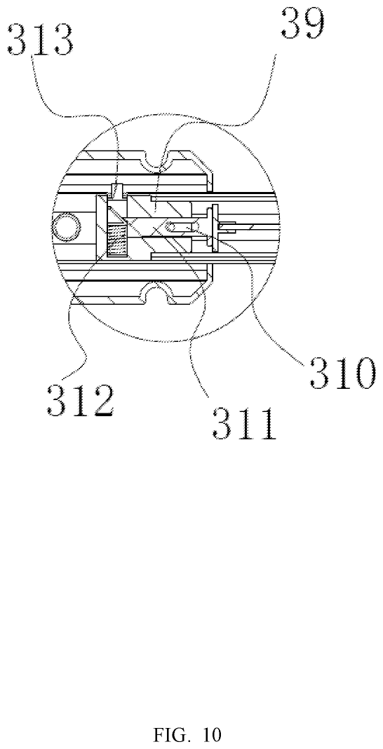

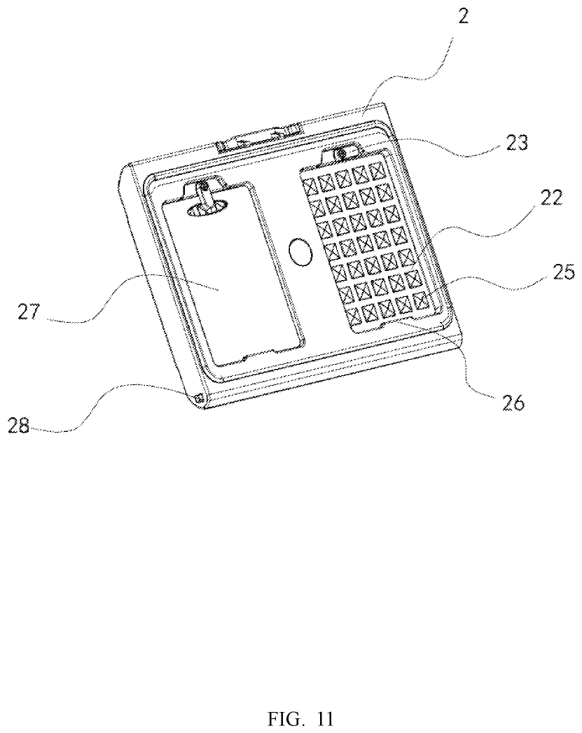

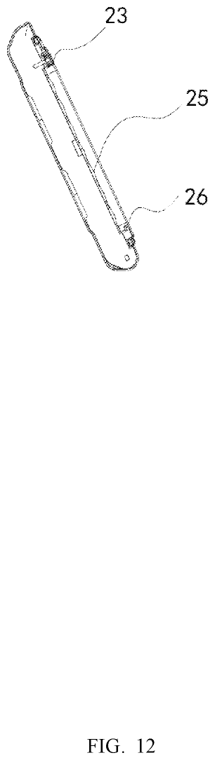

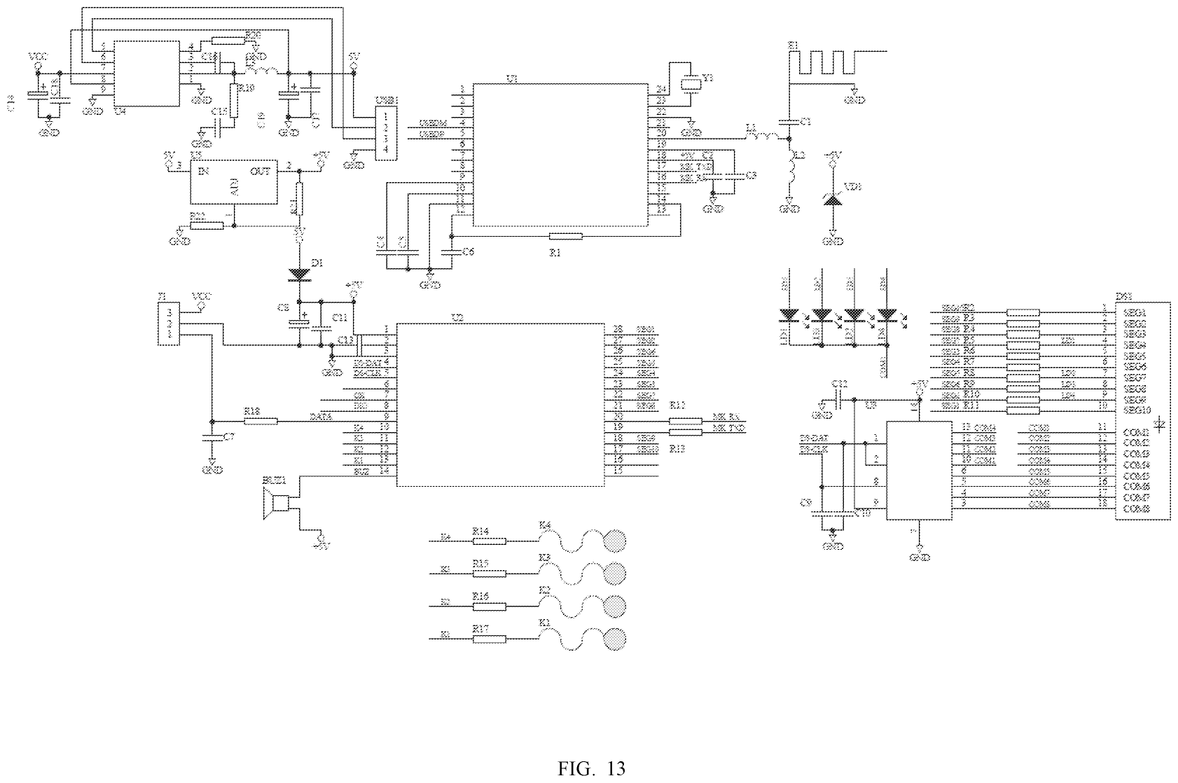

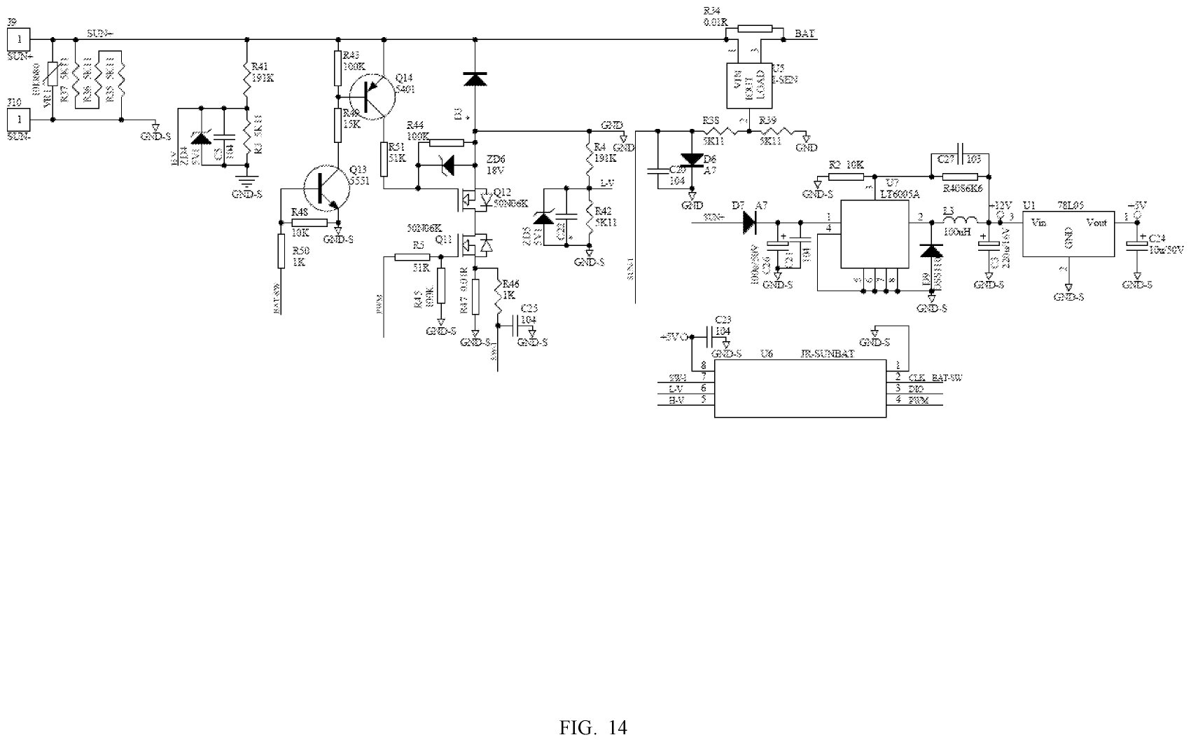

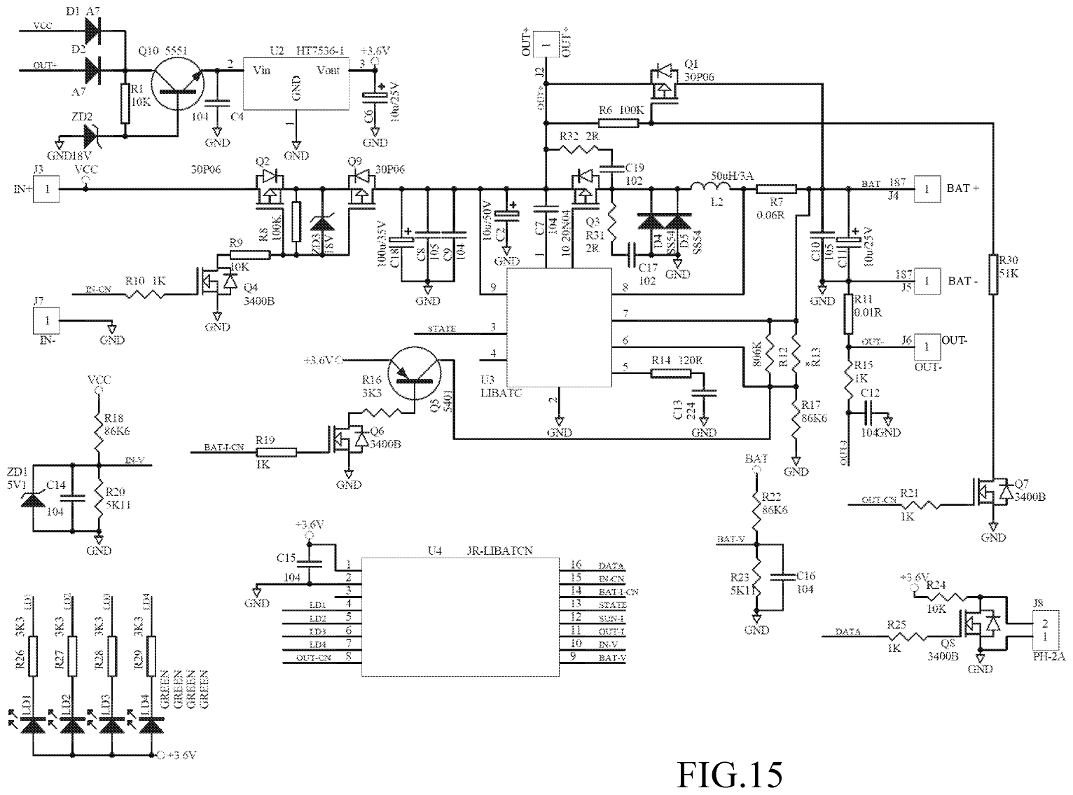

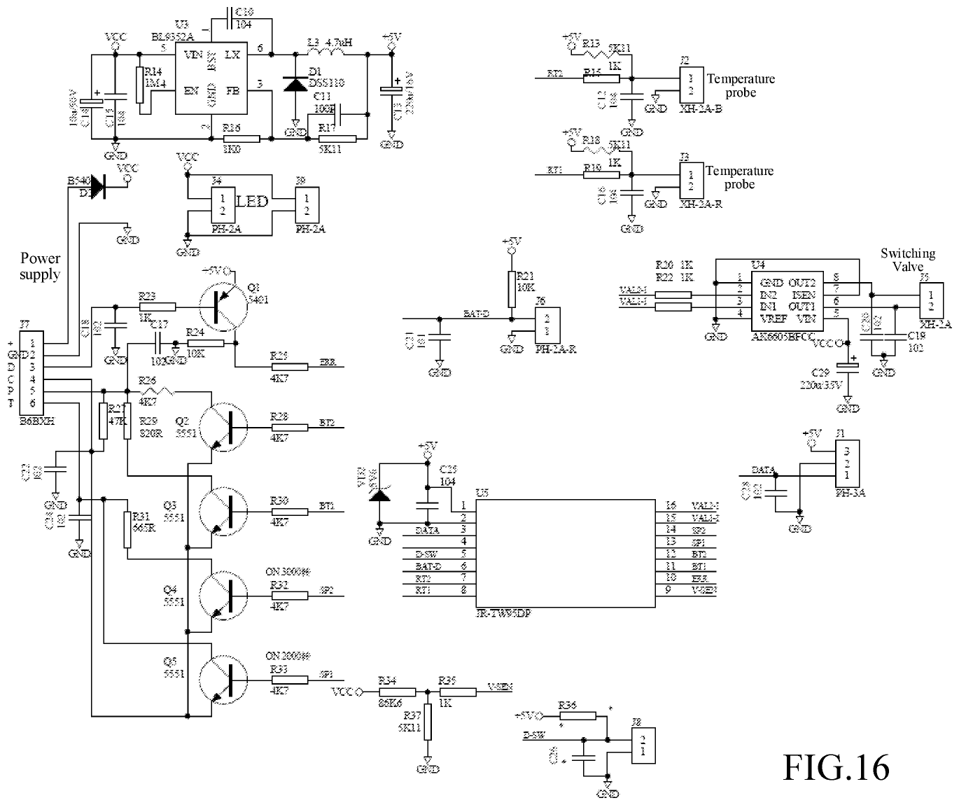

As illustrated in FIGS. 1 to 16, the present disclosure provides a multifunctional vehicle-mounted refrigerator with a plug-in battery, which includes a refrigerator box 1 and an openable cover 2 that is arranged on the top of the refrigerator box 1. The vehicle-mounted refrigerator further includes a refrigerating chamber 12 and a freezing chamber 11 that are arranged side by side in the refrigerator box 1, and a compressor 20 is installed at the bottom of one side of the refrigerator box 1.

The vehicle-mounted refrigerator further includes a roller 7 arranged at one end of the bottom of the refrigerator box 1 and a telescopic pull rod 3 arranged at the other end of the refrigerator box 1.

A battery chamber 10 is provided in one side wall of the refrigerator box 1, and a battery 5 is operative to be inserted into the battery chamber 10. The battery 5 includes a battery box 51 and a battery cover 52 arranged at the upper end of the battery box 51. Laterally movable buckle plates 53 are symmetrically arranged at both ends of the battery cover 52. The two ends of the buckle plates 53 protrude from the respective ends of the battery cover 52. The central portion of the buckle plates 53 is disposed outside the battery cover 52. The buckle plates 53 at both ends are connected together by an elastic piece 57. The elastic piece 57 is disposed in a limit groove 59 defined in an inner side of the battery cover 52. A conductive socket 9 is arranged in the battery chamber 10, and a conductive plug disposed on one side of the battery box 51 is operative to be plugged into the conductive socket 9.

A display and a control board coupled to it are installed on the upper side of the refrigerator box 1 for controlling the operation of the entire refrigerator.

It is only needed to move the buckle plates 53 at both ends to make the protruding parts of the buckle plates 53 detach from the vehicle-mounted refrigerator, and the buckle plates 53 will automatically recover under the action of the elastic pieces 57 after being released.

The limit slot 59 can limit the position of the elastic piece 57 to ensure that the buckle plates 3 at both ends are relatively stable when they are returned, and there will be no jamming.

The inner side of the buckle plate 53 is provided with a connecting groove 58 at a position corresponding to the elastic piece 57. The end of the connecting groove 58 is provided with an elastic piece connecting portion 510, and the elastic piece 57 is a spring. The elastic piece connecting portion 510 includes an insert plate and a spring insert pin arranged at the end of the insert plate, which can be mated with the insert plate through the spring, and the spring insert pin axially extends into the inside of the spring to fix the end of the spring, ensuring that the force is evenly applied when the spring is compressed.

In one embodiment, a switch button 54 is installed on the battery cover 52, and a power indicator 55 and a status indicator 56 are arranged on one side of the switch button 54. The switch button 54, the power indicator 55 and the status indicator 56 are all coupled to a control circuit board arranged on an inner side of the battery cover 52, thus facilitating the installation and removal of the battery to and from the car refrigerator, and the battery can be used for temporary use when used outdoors.

In one embodiment, both sides of the refrigerator box 1 are each installed with a pair of pull rod mounts 18, and a pull rod fixing tube 17 is connected between the pull rod mounts 18 on disposed on each side. An axially movable pull rod inner tube 36 is installed inside the pull rod fixing tube 17. One end of the two pull rod inner tubes 36 is connected by a pull rod 3. A movable shaft plug 38 is axially inserted into and arranged at one end of each of the pull rod inner tubes 36 connected with the pull rod 3. The outer end of the movable shaft plug 38 is provided with an unlocking knob 19 that is installed on a side wall of the pull rod 3. When the unlocking knob 19 is rotated, the movable shaft plug 38 is pushed to move axially. A fixing shaft plug 39 is installed at the other end of the pull rod inner tube 36. A lock tongue 313 is radially movably arranged inside the fixing shaft plug 39. One end of the lock tongue 313 is equipped with a spring 312, and the other end is inserted into a lock hole defined in the side wall of the pull rod fixing tube 17. An unlocking push rod 311 is arranged axially movable in the fixing shaft plug 39. One end of the unlocking push rod 311 is provided with a slope and inserted into the middle of the lock tongue 313 to push the lock tongue 313 to move radially, and the other end of the unlocking push rod 311 is connected with the movable shaft plug 38 through a connecting shaft 37.

When unlocking, turn the unlocking knob 19 to rotate, and push the movable shaft plug 38 to move axially, and the unlocking push rod 311 is driven to move axially through the connecting shaft 37, and the tongue 313 is pushed back, so that the pull rod 3 can be pulled to pull out the pull rod inner tube 36 thereby realizing the unlocking and stretching of the pull rod.

In addition, the unlocking push rod 311 may be provided with an elongated limiting hole 310, and a protrusion inside the fixing shaft plug 39 may be embedded in the elongated limiting hole 310 to limit the distance of travel of the unlocking push rod 311.

A notch is provided in a side wall of the pull rod 3, and the unlocking knob 19 is installed in the notch, and is connected to the side wall at one end of the notch through a rotating shaft.

As an embodiment, the inner side wall of the cover 2 is provided with at least one groove 22. A detachable fruit cutting board 27 is embedded in the groove 22. One end of the groove 22 is equipped with a rotating blocking plate 23, and the other end is provided with a convex plate 26 on the side wall, and both ends of the fruit cutting board 27 are restricted in the groove 22 by the rotating blocking plate 23 and the convex plate 26. The inner bottom surface of the groove 22 is evenly distributed with raised blocks 25.

When in use, the fruit cutting board 27 can be taken out of the groove 22, and fruits or other foods can be placed on the fruit cutting board 27 for cutting. The fruit cutting board 27 may be an ordinary household cutting board. The size of the groove 22 matches the fruit cutting board 27. There are usually two grooves 22, and one or two fruit cutting boards 27 can be installed as needed.

As a method of fixing the fruit cutting board 27, a rotating blocking plate 3 may be installed at one end of the groove 22, and a convex plate 26 may be arranged on the side wall of the other end. As such, the two ends of the fruit cutting board 27 are restricted in the groove 22 by the rotating blocking plate 23 and the convex plate 26, and the fruit cutting board 27 can be installed and removed by way of turning the rotating blocking plate 23.

In order to facilitate the installation of the rotating blocking plate 23, one end of the groove 22 may be provided with a receding inner slot, and one end of the rotating blocking plate 23 is connected with a rotating shaft arranged in the middle of the receding inner slot.

The inner bottom surface of the groove 22 is uniformly distributed with raised blocks 25, the raised blocks 25 are in the shape of a square truncated cone, and the top of the raised blocks 25 is pointed, and is in point contact with the fruit cutting board 27, so as to keep the surface of the fruit cutting board 27 dry and reduce the growth of bacteria.

A corner protection board 16 may be installed at the bottom of one end of the refrigerator box 1 that is not equipped with rollers 7, and a corner protection boss 35 may be arranged transversely on the inner side of the corner protection board 16, and slopes are arranged on both sides of the corner protection boss 35. The corner protection boss 35 can protect the corner protection board 16 from being hit, thus effectively protecting the corner protection board 16.

As another embodiment, a rotating shaft 28 may be symmetrically arranged between the two ends at one side of the cover 2. In the center of the side of the cover 2 facing away from the rotating shaft 28 may be installed a flip buckle cover 8, which is operative to be interlocked with the upper edge of the refrigerator box 1. The two ends of an inner side wall at the top of the refrigerator box 1 may be provided with vertical slots 14, and the bottom of each of the vertical slots 14 is provided with a circular slot 15, and the rotating shaft 28 is inserted and embedded into the circular slot 15 along the vertical slot 14 at either end. The cover 2 can be installed such that it opens to the left or to the right, thus providing strong versatility.

At least two types of power sockets 6 may be installed on one side of the refrigerator box 1 under the battery chamber 10, and a charging management board may be installed inside, and the power input mode can be freely selected.

A storage basket 13 may be installed inside the refrigerating chamber 12 and/or the freezing chamber 11, which can be used to place items to withstand the weight of the items.

Although the present disclosure has been described above with reference to the embodiments, various modifications can be made thereto and the components and elements described therein can be replaced with equivalents without departing from the scope of the present disclosure. In particular, as long as no structural conflict is present, the various features in the embodiments disclosed in the present disclosure can be combined with each other in any manner possible. These combinations are not exhausted in this specification only for the sake of omitting space and saving resources. Therefore, the present disclosure will not be limited to the specific embodiments disclosed herein, but is intended to encompass all technical solutions falling in the scope of the appended claims.

What is claimed is:

1. A multifunctional vehicle-mounted refrigerator with a plug-in battery, comprising a refrigerator box, an openable cover arranged on a top of the refrigerator box, a refrigerating chamber and a freezing chamber that are arranged side by side in the refrigerator box, and a compressor that is installed at a bottom of one side of the refrigerator box;
wherein the vehicle-mounted refrigerator further comprises a roller arranged at one end of the bottom of the refrigerator box and a telescopic pull rod arranged at another end of the refrigerator box;
wherein a battery chamber is defined in a side wall of the refrigerator box, and a battery is operative to be inserted into the battery chamber, wherein the battery comprises a battery box and a battery cover arranged at an upper end of the battery box, wherein laterally movable buckle plates are symmetrically arranged between two ends of the battery cover, wherein two ends of the buckle plates extend out of respective ends of the battery cover, a central portion of the buckle plates is disposed outside the battery cover, and the buckle plates at both ends are connected by an elastic piece, which is disposed in a limiting groove defined in an inner side of the battery cover, wherein a conductive socket is arranged in the battery chamber, and a conductive plug disposed on a side of the battery box is operative to be plugged into the conductive socket.

2. The multifunctional vehicle-mounted refrigerator of claim 1, wherein a connecting groove is defined in an inner side of the buckle plates at a position corresponding to the elastic piece, and an elastic piece connecting portion is arranged at an end of the connecting groove.

3. The multifunctional vehicle-mounted refrigerator of claim 2, wherein the elastic piece is a spring, and the elastic piece connecting portion comprises an insert plate, and a spring insert pin that is arranged at an end of the insert plate and that is operative to be mated with the insert plate through the spring, and wherein the spring insert pin is operative to axially extend into an inside of the spring to fix and end of the spring, ensuring that an elastic force is evenly applied when the spring is compressed.

4. The multifunctional vehicle-mounted refrigerator of claim 1, wherein a switch button is installed on the battery cover, and a power indicator and a status indicator are arranged on one side of the switch button, wherein the switch button, the power indicator and the status indicator are all coupled to a control circuit board disposed on an inner side of the battery cover.

5. The multifunctional vehicle-mounted refrigerator of claim 1, wherein a pair of pull rod mounts are installed at each of both sides of the refrigerator box, and a pull rod fixing tube is connected between the pull rod mounts disposed on each side, wherein an axially movable pull rod inner tube is installed inside the pull rod fixing tube, one end of the two pull rod inner tubes is connected by a pull rod, a movable shaft plug is axially inserted into and arranged at one end of each of the pull rod inner tubes that is connected with the pull rod, an outer end of the movable shaft plug is provided with an unlocking knob that is installed on a side wall of the pull rod, wherein when the unlocking knob is rotated, the movable shaft plug is pushed to move axially, wherein a fixing shaft plug is installed at another end of the pull rod inner tube, a lock tongue is radially movably arranged inside the fixing shaft plug, wherein one end of the lock tongue is equipped with a spring, and another end is inserted into a lock hole defined in a side wall of the pull rod fixing tube, wherein an unlocking push rod is arranged axially movable in the fixing shaft plug, wherein one end of the unlocking push rod is provided with a slope and is operative to be inserted into a middle of the lock tongue configured to push the lock tongue to move radially, and another end of the unlocking push rod is connected with the movable shaft plug through a connecting shaft.

6. The multifunctional vehicle-mounted refrigerator of claim 5, wherein a notch is defined in a side wall of the pull rod, and the unlocking knob is installed in the notch and is connected to the side wall at one end of the notch through a rotating shaft.

7. The multifunctional vehicle-mounted refrigerator of claim 5, wherein the unlocking push rod is defined with an elongated limiting hole, and a protrusion disposed inside the fixing shaft plug is embedded in the elongated limiting hole.

8. The multifunctional vehicle-mounted refrigerator of claim 1, wherein at least one groove is defined in an inner side wall of the box cover, and a detachable fruit cutting board is embedded in the at least one groove, wherein a rotating blocking plate is installed at one end of the at least one groove, and a convex plate is installed on a side wall at another end, wherein both ends of the fruit cutting board are restricted in the groove by the rotating blocking plate and the convex plate, and an inner bottom surface of the groove is evenly distributed with raised blocks.

9. The multifunctional vehicle-mounted refrigerator of claim 8, wherein the raised blocks are in the shape of a square truncated cone, and have a pointed top and is in point contact with the fruit cutting board so as to keep a surface of the fruit cutting board dry and reduce the growth of bacteria.

10. The multifunctional vehicle-mounted refrigerator of claim 8, wherein one end of the groove is defined with a receding inner slot, and one end of the rotating blocking plate is connected with a rotating shaft arranged in a middle of the receding inner slot.

11. The multifunctional vehicle-mounted refrigerator of claim 1, wherein a corner protection board is installed at the bottom of one end of the refrigerator box that is not equipped with rollers, and a corner protection boss is arranged transversely on the inner side of the corner protection board, and slopes are arranged on both sides of the corner protection boss.

12. The multifunctional vehicle-mounted refrigerator of claim 1, wherein a rotating shaft is symmetrically arranged between two ends at one side of the cover, wherein in a center of the side of the cover facing away from the rotating shaft is installed a flip buckle cover, which is operative to be interlocked with an upper edge of the refrigerator box, wherein two ends of an inner side wall at the top of the refrigerator box are defined with vertical slots, and a circular slot is provided at the bottom of each of the vertical slots, and wherein the rotating shaft is inserted and embedded into the circular slot along the vertical slot at either end.

13. The multifunctional vehicle-mounted refrigerator of claim 1, wherein at least two types of power sockets are installed at the side of the refrigerator box below the battery chamber.

14. The multifunctional vehicle-mounted refrigerator of claim 1, wherein a storage basket is installed inside at least one selected from the group consisting of the refrigerating chamber and the freezing chamber.
